(19) United States
(12) Patent Application Publication
(10) Pub. No.: US 2019/0266889 A1
(43) Pub. Date: Aug. 29, 2019

(54) VEHICLE CONTROL DEVICE

(71) Applicant: HONDA MOTOR CO., LTD., Tokyo (JP)

(72) Inventors: Toshifumi SUZUKI, WAKO-SHI (JP); Hiroshi MIURA, WAKO-SHI (JP); Marina SAIKYO, WAKO-SHI (JP); Suguru YANAGIHARA, WAKO-SHI (JP); Yuta TAKADA, TOKYO (JP); Shogo KOBAYASHI, WAKO-SHI (JP)

(21) Appl. No.: 16/284,637

(22) Filed: Feb. 25, 2019

(30) Foreign Application Priority Data
Feb. 26, 2018 (JP) 2018-031557

(51) Int. Cl. G08G 1/01; B60W 30/165

(52) U.S. Cl. CPC G08G 1/0112; B60W 10/18; B60W 30/165

(57) ABSTRACT

When a host vehicle crosses a track of a streetcar, if an external environment recognition unit recognizes a stop line (or a section line) between the host vehicle and the track, a stop position setting unit sets the stop line as a target stop position. In addition, if the external environment recognition unit does not recognize the stop line between the host vehicle and the track, the stop position setting unit sets a predetermined position that is separated from the track toward the host vehicle as the target stop position.

### CROSS-REFERENCE TO RELATED APPLICATION

This application is based upon and claims the benefit of priority from Japanese Patent Application No. 2018-031557 filed on Feb. 26, 2018, the contents of which are incorporated herein by reference.

### BACKGROUND OF THE INVENTION

### Field of the Invention

The present invention relates to a vehicle control device that performs automated driving or driving assistance of a host vehicle, and particularly a vehicle control device that controls the host vehicle on a road where a railroad track of a streetcar is laid.

### Description of the Related Art

Japanese Laid-Open Patent Publication No. 2008-293269 discloses a navigation device. In a case where a host vehicle driven by a vehicle occupant turns right to cross a track of a streetcar and the streetcar approaches the host vehicle from behind, this navigation device notifies the vehicle occupant of an approach of the streetcar.

Incidentally, an automated driving vehicle or a driving assistance vehicle, in which at least one of driving force output control, braking control, and steering control of a host vehicle is performed by a vehicle control device, has been developed. In the present specification, the driving assistance is regarded as one type of the automated driving, and the driving assistance vehicle is included in the automated driving vehicle. The automated driving vehicle needs to perform appropriate travel control when crossing the track of the streetcar as disclosed in Japanese Laid-Open Patent Publication No. 2008-293269.

### SUMMARY OF THE INVENTION

The navigation device according to Japanese Laid-Open Patent Publication No. 2008-293269 merely notifies the vehicle occupant when recognizing the streetcar, and the travel control of the host vehicle is not disclosed.

The present invention has been made in consideration of such a circumstance, and an object is to provide a vehicle control device that can perform appropriate travel control when crossing a track of a streetcar.

A vehicle control device according to the present invention includes: an external environment recognition unit configured to recognize a peripheral state of a host vehicle; a stop position setting unit configured to set a target stop position of the host vehicle on a basis of the peripheral state that is recognized by the external environment recognition unit; and a vehicle control unit configured to perform stop control to temporarily stop the host vehicle at the target stop position that is set by the stop position setting unit, wherein: if the host vehicle crosses a track of a streetcar and the external environment recognition unit recognizes a stop line between the host vehicle and the track, the stop position setting unit is configured to set the stop line as the target stop position; and if the host vehicle crosses the track of the streetcar and the external environment recognition unit does not recognize the stop line between the host vehicle and the track, the stop position setting unit is configured to set a predetermined position that is separated from the track toward the host vehicle as the target stop position.

In the above configuration, when the host vehicle crosses the track of the streetcar, the stop line or the predetermined position that is separated from the track toward the host vehicle is set as the target stop position. That is to say, the host vehicle can be stopped temporarily before the track of the streetcar regardless of whether the stop line is set and whether the stop line can be recognized.

The vehicle control device according to the present invention may further include a notification control unit configured to perform notification control to notify a reason to stop to a vehicle occupant of the host vehicle in a case where the vehicle control unit performs the stop control.

In the above configuration, the vehicle occupant can understand the reason why the host vehicle has decelerated or stopped.

The vehicle control device according to the present invention may further include a notification control unit configured to perform notification control to prompt a vehicle occupant of the host vehicle to select whether to temporarily stop the host vehicle before the track or not, wherein the stop position setting unit may be configured to set the target stop position in a case where the vehicle occupant selects to stop the host vehicle.

In the above configuration, automated driving in accordance with the vehicle occupant's intention can be performed. For example, if the vehicle occupant confirms that the streetcar will not approach the position where the host vehicle crosses the track, the operation of temporarily stopping the host vehicle before the track can be omitted.

In the present invention, if the external environment recognition unit does not recognize the stop line between the host vehicle and the track, the stop position setting unit may be configured to set a position that is separated from the track toward the host vehicle by a predetermined distance as the target stop position.

In the above configuration, even if the stop line cannot be recognized, the target stop position can be set as long as the position of the track can be recognized.

In the present invention, if the external environment recognition unit does not recognize the stop line between the host vehicle and the track, the stop position setting unit may be configured to set as the target stop position, a position where a color of a road surface changes between the host vehicle and the track or a position that is separated from the position where the color of the road surface changes by a predetermined distance.

In the above configuration, even if the stop line cannot be recognized, the target stop position can be set as long as the position where the color of the road surface changes can be recognized.

In the present invention, if the host vehicle goes straight to cross the track of the streetcar and the external environment recognition unit does not recognize the stop line between the host vehicle and the track, the stop position setting unit may be configured to set as the target stop position, a position where a preceding vehicle that travels ahead of the host vehicle stops.

In the above configuration, even if the stop line cannot be recognized, the target stop position can be set as long as the position where the preceding vehicle stops can be recognized.

In the present invention, if the host vehicle goes straight to cross the track of the streetcar and the external environment recognition unit does not recognize the stop line between the host vehicle and the track, the stop position setting unit may be configured to set as the target stop position, a position that is separated by a predetermined distance from a position where an oncoming vehicle that travels toward the host vehicle stops.

In the above configuration, even if the stop line cannot be recognized, the target stop position can be set as long as the position where the oncoming vehicle stops can be recognized.

According to the present invention, the host vehicle can be temporarily stopped before the track of the streetcar regardless of whether the stop line is set and whether the stop line can be recognized.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a host vehicle including a vehicle control device according to one embodiment;

FIG. 2 is a function block diagram of a calculation device;

FIG. 3 is a flowchart of a main process to be performed by the vehicle control device according to the present embodiment; and

FIG. 4 is a diagram for describing a target stop position that is set in a circumstance where the host vehicle crosses a track of a streetcar.

### DESCRIPTION OF THE PREFERRED EMBODIMENTS

A preferred embodiment of a vehicle control device according to the present invention will be described in detail with reference to the attached drawings.

### 1. Configuration of Host Vehicle 10

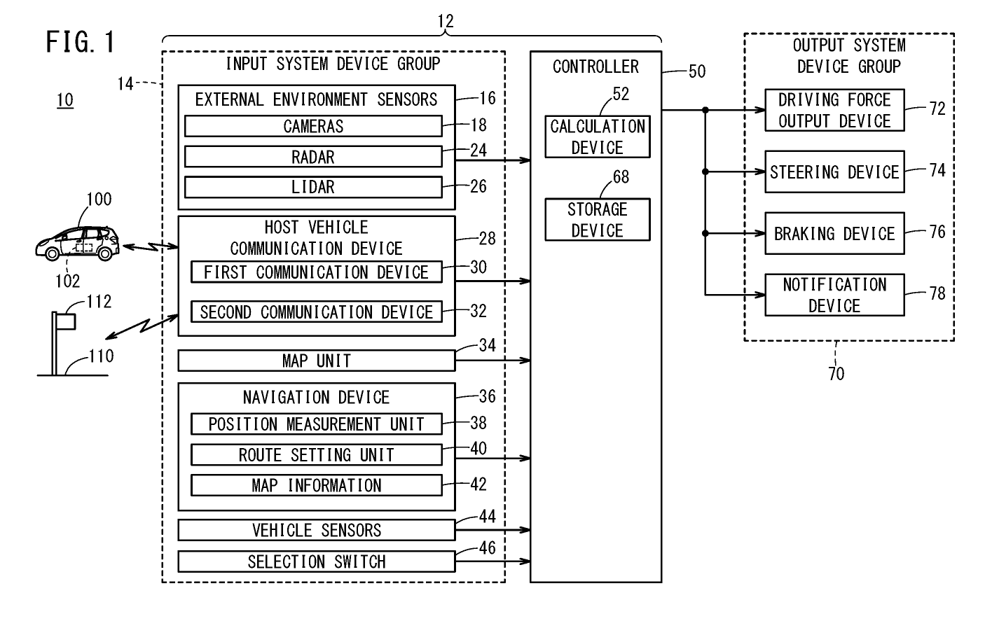

As illustrated in FIG. 1, a host vehicle 10 includes an input system device group 14 that acquires or stores various kinds of information, a controller 50 to which information output from the input system device group 14 is input, and an output system device group 70 that operates in accordance with various instructions output from the controller 50. A vehicle control device 12 according to the present embodiment includes the input system device group 14 and the controller 50. The host vehicle 10 is an automated driving vehicle in which travel control is performed by the controller 50 (including fully automated driving vehicle) or a driving assistance vehicle in which travel control is assisted partially.

### 1.1. Input System Device Group 14

The input system device group 14 includes an external environment sensor 16, a host vehicle communication device 28, a map unit 34, a navigation device 36, vehicle sensors 44, and a selection switch 46. The external environment sensor 16 detects a state of a periphery (external environment) of the host vehicle 10. The external environment sensor 16 includes a plurality of cameras 18 that capture images of the external environment, a plurality of radars 24 that detects the distance and the relative speed between the host vehicle 10 and peripheral objects, and one or more lidars 26. The host vehicle communication device 28 includes a first communication device 30 and a second communication device 32. The first communication device 30 performs inter-vehicle communication with an other-vehicle communication device 102 provided on another vehicle 100 to acquire external environment information including information regarding the other vehicle 100 (such as a type of vehicle, a travel state, or a travel position). The second communication device 32 performs road-vehicle communication with a road-side communication device 112 provided on an infrastructure such as a road 110 to acquire external environment information including the road information (such as information regarding a traffic light or a traffic jam). The map unit 34 stores a high-precision map the positional precision of which is less than or equal to centimeter units. The navigation device 36 includes a position measurement unit 38 that measures the position of the host vehicle 10 by a satellite navigation method and/or a self-contained navigation method, map information 42, and a route setting unit 40 that sets a scheduled route from the position of the host vehicle 10 to a destination on the basis of the map information 42. The vehicle sensors 44 detect the travel state of the host vehicle 10. The vehicle sensors 44 include a vehicle speed sensor, an acceleration sensor, a yaw rate sensor, an inclination sensor, a travel distance sensor, and the like, that are not shown. The selection switch 46 outputs a signal expressing whether a temporary stop is necessary in accordance with an operation of the vehicle occupant.

### 1.2. Output System Device Group 70

The output system device group 70 includes a driving force output device 72, a steering device 74, a braking device 76, and a notification device 78. The driving force output device 72 includes a driving force output ECU, and a driving source such as an engine or a traction motor. The driving force output device 72 generates driving force in accordance with a vehicle occupant's operation of an accelerator pedal or a driving control instruction that is output from the controller 50. The steering device 74 includes an electric power steering system (EPS) ECU and an EPS actuator. The steering device 74 generates a steering force in accordance with a vehicle occupant's operation of a steering wheel or a steering control instruction that is output from the controller 50. The braking device 76 includes a braking ECU and a braking actuator. The braking device 76 generates a braking force in accordance with a vehicle occupant's operation of a braking pedal or a braking control instruction that is output from the controller 50. The notification device 78 includes a notification ECU and an information transmission device (such as a display device, an audio device, or a haptic device). The notification device 78 notifies a vehicle occupant in accordance with a notification instruction that is output from the controller 50 or another ECU.

### 1.3. Controller 50

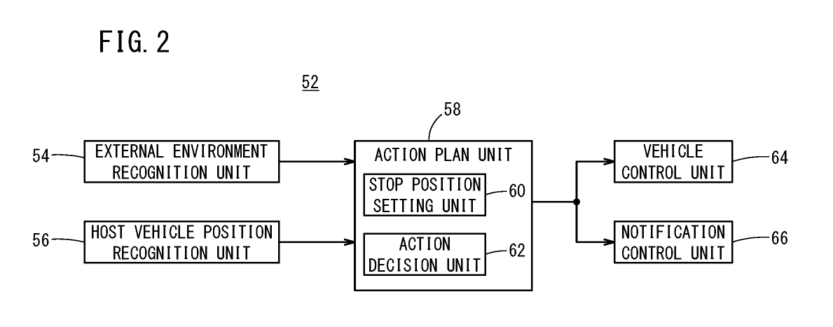

The controller 50 is configured by an ECU, and includes a calculation device 52 such as a processor and a storage device 68 such as a ROM or a RAM. The controller 50 achieves various functions when the calculation device 52 executes programs stored in the storage device 68. As illustrated in FIG. 2, the calculation device 52 functions as an external environment recognition unit 54, a host vehicle position recognition unit 56, an action plan unit 58, a vehicle control unit 64, and a notification control unit 66.

The external environment recognition unit 54 recognizes the peripheral state of the host vehicle 10 on the basis of the information output from the external environment sensor 16, the host vehicle communication device 28, the map unit 34, and the navigation device 36. For example, the external environment recognition unit 54 recognizes the existence, position, size, type, and travel direction of the other vehicle 100 that travels or stops near the host vehicle 10 and moreover recognizes the distance and the relative speed between the host vehicle 10 and the other vehicle 100, on the basis of image information acquired by the cameras 18, information acquired by the radars 24 and the lidars 26, and the external environment information acquired by the first communication device 30. In addition, the external environment recognition unit 54 recognizes the shape and the position of an object included in the road environment (such as roads 110, lane marks, median strips, facilities near the roads, and spaces) on the basis of the image information acquired by the cameras 18, the information acquired by the radars 24 and the lidars 26, a high-precision map stored in the map unit 34, the map information 42 stored in the navigation device 36, and the external environment information acquired by the second communication device 32. The external environment recognition unit 54 recognizes a signal of a traffic light (a forward traveling permissible state, a forward traveling prohibited state) on the basis of the image information acquired by the cameras 18 or the external environment information acquired by the second communication device 32.

The host vehicle position recognition unit 56 recognizes the position of the host vehicle 10 on the basis of the information output from the map unit 34 and the navigation device 36.

The action plan unit 58 plans an action that is optimal to the host vehicle 10 on the basis of a recognition result from the external environment recognition unit 54 and the host vehicle position recognition unit 56, and the detected information and stored information of the input system device group 14. The action plan unit 58 includes a stop position setting unit 60 and an action decision unit 62. The stop position setting unit 60 sets a target stop position 128 of the host vehicle 10 on the basis of the peripheral state that is recognized by the external environment recognition unit 54. The action decision unit 62 decides an action in accordance with a generated event, and generates a travel trajectory and a target speed when the travel control is performed.

The vehicle control unit 64 controls the output system device group 70 on the basis of the action planned by the action plan unit 58. For example, the vehicle control unit 64 calculates a steering instruction value based on the travel trajectory generated by the action plan unit 58, and an acceleration/deceleration instruction value based on the target speed, and outputs control instructions to the driving force output device 72, the steering device 74, and the braking device 76.

The notification control unit 66 outputs the notification instruction to the notification device 78 on the basis of a notification action planned by the action plan unit 58.

The storage device 68 illustrated in FIG. 1 stores numerals such as thresholds used in comparison, determination, or the like in each process, in addition to various programs to be executed by the calculation device 52.

### 2. Operation of Vehicle Control Device 12

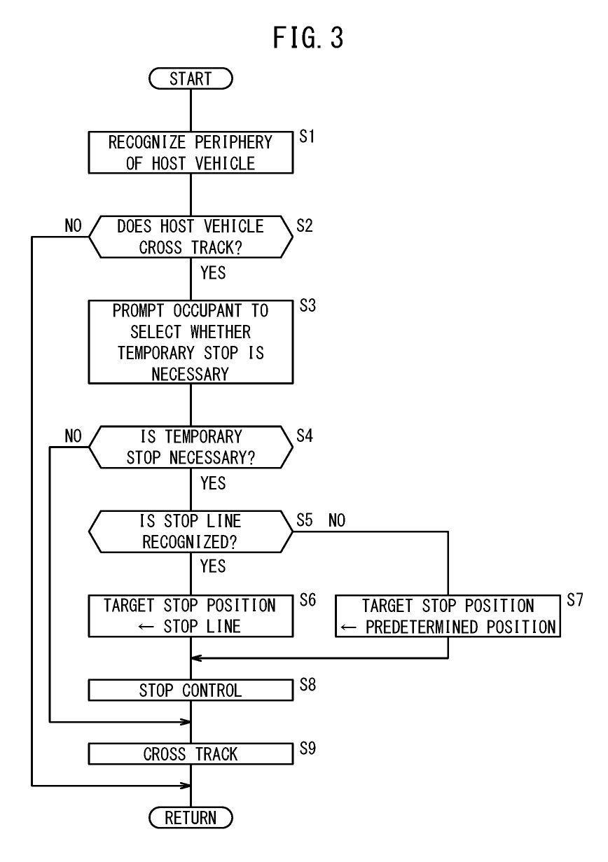

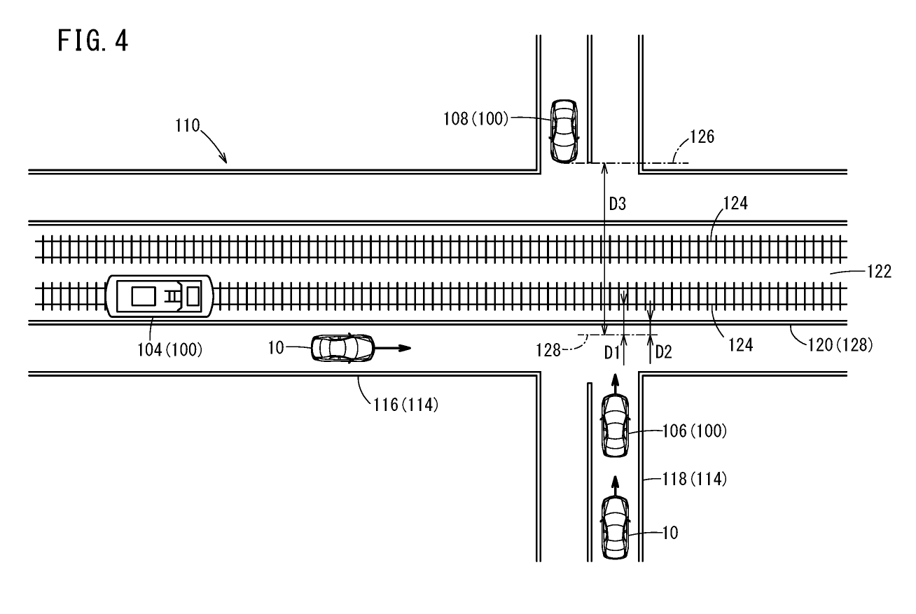

An operation of the vehicle control device 12 is described with reference to FIG. 3. The present embodiment describes two circumstances illustrated in FIG. 4. In one circumstance, the host vehicle 10 travels in a first travel path 116 that is parallel to a track (or a railroad track) 124 of a streetcar 104 and the host vehicle 10 turns left from the first travel path 116 to cross the track 124 of the streetcar 104. In the other circumstance, the host vehicle 10 travels in a second travel path 118 crossing the track 124 of the streetcar 104 and the host vehicle 10 goes straight to cross the track 124 of the streetcar 104. Note that FIG. 4 illustrates an area where vehicles keep right.

In step S1, the external environment recognition unit 54 recognizes a peripheral state of the host vehicle 10 on the basis of the latest information that is output from the input system device group 14. For example, the external environment recognition unit 54 recognizes the other vehicle 100 (the streetcar 104, a preceding vehicle 106, an oncoming vehicle 108), the first travel path 116, the second travel path 118, a section line 120, a track (or a streetcar railroad track) laid area 122, the track 124, and the like that are illustrated in FIG. 4.

In step S2, the action decision unit 62 determines an event that is generated in the host vehicle 10, on the basis of the position of the host vehicle 10 that is recognized by the host vehicle position recognition unit 56, the map information 42 or the information in the map unit 34, and the scheduled route. As illustrated in FIG. 4, if a travel scheduled route crossing the track 124 exists within a predetermined distance in the travel direction of the host vehicle 10, an event of crossing the track 124 is generated. If the host vehicle 10 crosses the track 124 (step S2: YES), the process advances to step S3. On the other hand, if the host vehicle 10 does not cross the track 124 (step S2: NO), a series of processes in FIG. 3 is terminated once.

When the process has advanced from step S2 to step S3, the action decision unit 62 decides to notify the vehicle occupant. The notification control unit 66 outputs a notification instruction to the notification device 78 in accordance with a decision of the action decision unit 62. The notification device 78, for example, a display device or an audio device, outputs a message to prompt the vehicle occupant to select whether to temporarily stop the host vehicle 10 before the track 124.

In step S4, the action decision unit 62 determines whether the temporary stop is necessary. When the vehicle occupant who has been notified in step S3 operates the selection switch 46, the selection switch 46 outputs a signal expressing whether the temporary stop is necessary. If the signal expressing that the temporary stop is necessary is output or if the signal expressing whether the temporary stop is necessary is not output within a predetermined period after the notification, the action decision unit 62 determines that the temporary stop is necessary. On the other hand, if the signal expressing that the temporary stop is unnecessary is output, the action decision unit 62 determines that the temporary stop is unnecessary. If the temporary stop is necessary (step S4: YES), the process advances to step S5. On the other hand, if the temporary stop is unnecessary (step S4: NO), the process advances to step S9.

When the process has advanced from step S4 to step S5, the external environment recognition unit 54 determines whether a stop line is recognized before a position where the host vehicle 10 crosses the track 124 and between the host vehicle 10 and the track 124 on the basis of the image information. As illustrated in FIG. 4, there is a place where the section line 120 is provided between the track laid area 122 and a travel path 114. In the present embodiment, this section line 120 is the stop line where the host vehicle 10 should stop. The external environment recognition unit 54 can recognize the stop line. If the external environment recognition unit 54 can recognize the section line 120 as the stop line (step S5: YES), the process advances to step S6. On the other hand, there is a place where the section line 120 is not provided between the track laid area 122 and the travel path 114. In such a place, the external environment recognition unit 54 cannot recognize the stop line. If the external environment recognition unit 54 cannot recognize the section line 120 as the stop line (step S5: NO), the process advances to step S7.

If the section line 120 has been faded, the external environment recognition unit 54 recognizes the section line 120 as the section line 120 with low reliability. If the external environment recognition unit 54 recognizes the section line 120 but the reliability is low in step S5, the process advances to step S7.

When the process has advanced from step S5 to step S6, the stop position setting unit 60 sets the section line 120 as the target stop position 128. On the other hand, when the process has advanced from step S5 to step S7, the stop position setting unit 60 sets a predetermined position as the target stop position 128. The predetermined position can be determined by any one of the following methods.

In one example, the stop position setting unit 60 uses the track 124 that is recognized by the external environment recognition unit 54 as a reference position, and sets a position that is separated from the reference position toward the host vehicle 10 by a predetermined distance D1 as the predetermined position. The position that is separated from the reference position toward the host vehicle 10 refers to a position that is separated from a reference position on the side of the approaching host vehicle 10. The external environment recognition unit 54 can recognize the position of the track 124 on the basis of the image information of the cameras 18, and also recognize the position of the track 124 on the basis of a difference in reflectance from the radar 24.

In another example, the stop position setting unit 60 uses a border between the travel path 114 and the track laid area 122 where the track 124 is laid, as the reference position, and sets a position that is separated from the reference position toward the host vehicle 10 by a predetermined distance D2 as the predetermined position. The predetermined distance D2 may be zero. That is to say, the border between the track laid area 122 and the travel path 114 may be used as the predetermined position. The track laid area 122 and the travel path 114 are different in color on the road surface. The external environment recognition unit 54 can recognize the position of the border between the track laid area 122 and the travel path 114 on the basis of the image information of the cameras 18.

In another example, when the host vehicle 10 goes straight in the second travel path 118 to cross the track 124 of the streetcar 104, the stop position setting unit 60 can set a position where the preceding vehicle 106 that travels ahead of the host vehicle 10 stops, as the predetermined position.

In still another example, when the host vehicle 10 goes straight in the second travel path 118 to cross the track 124 of the streetcar 104, the stop position setting unit 60 can set as the predetermined position, a position that is separated by a predetermined distance D3 toward the host vehicle 10 from a position 126 where the oncoming vehicle 108 that travels toward the host vehicle 10 stops.

When the process has advanced from step S6 or step S7 to step S8, the action decision unit 62 generates a target speed and a travel trajectory that causes the host vehicle 10 to stop at the target stop position 128. The vehicle control unit 64 calculates the acceleration/deceleration instruction value and the steering instruction value that are necessary to cause the host vehicle 10 to stop at the target stop position 128 after traveling along the travel trajectory, and outputs the values to the output system device group 70. The driving force output device 72, the steering device 74, and the braking device 76 operate in accordance with the instructions output from the vehicle control unit 64. Thus, the host vehicle 10 stops with its host vehicle end position aligned with the target stop position 128.

In step S6, the action decision unit 62 decides to notify the vehicle occupant. The notification control unit 66 outputs the notification instruction to the notification device 78 in accordance with the decision of the action decision unit 62. The notification device 78, for example, the display device or the audio device, outputs a message to the vehicle occupant, and this message shows a reason to stop.

When the process has advanced from step S4 or step S8 to step S9, the action decision unit 62 generates the target speed and the travel trajectory that causes the host vehicle 10 to cross the track 124. If the host vehicle 10 stops temporarily before the track 124, the vehicle control unit 64 calculates the acceleration instruction value and the steering instruction value that cause the host vehicle 10 to start to travel and cross the track 124, and outputs the values to the output system device group 70. On the other hand, if the host vehicle 10 does not stop before the track 124, the vehicle control unit 64 calculates the acceleration instruction value and the steering instruction value that cause the host vehicle 10 to slow down and cross the track 124, and outputs the values to the output system device group 70. The driving force output device 72, the steering device 74, and the braking device 76 operate in accordance with the instructions output from the vehicle control unit 64. Thus, the host vehicle 10 crosses the track 124.

Note that the process may advance to step S5 without the notification process in step S3 and the determination process in step S4.

### 3. Summary of the Present Embodiment

The vehicle control device 12 includes the external environment recognition unit 54 configured to recognize the peripheral state of the host vehicle 10, the stop position setting unit 60 configured to set the target stop position 128 of the host vehicle 10 on the basis of the peripheral state that is recognized by the external environment recognition unit 54, and the vehicle control unit 64 configured to perform the stop control to temporarily stop the host vehicle 10 at the target stop position 128 that is set by the stop position setting unit 60. If the host vehicle 10 crosses the track 124 of the streetcar 104 and the external environment recognition unit 54 recognizes the stop line (section line 120) between the host vehicle 10 and the track 124, the stop position setting unit 60 is configured to set the stop line as the target stop position 128. In addition, if the host vehicle 10 crosses the track 124 of the streetcar 104 and the external environment recognition unit 54 does not recognize the stop line between the host vehicle 10 and the track 124, the stop position setting unit 60 is configured to set the predetermined position that is separated from the track 124 toward the host vehicle 10 as the target stop position 128.

In the above configuration, when the host vehicle 10 crosses the track 124 of the streetcar 104, the stop line or the predetermined position that is separated from the track 124 toward the host vehicle 10 is set as the target stop position 128. That is to say, the host vehicle 10 can be stopped temporarily before the track 124 of the streetcar 104 regardless of whether the stop line is set and whether the stop line can be recognized.

The vehicle control device 12 further includes the notification control unit 66 configured to perform the notification control to notify the reason to stop to the vehicle occupant of the host vehicle 10 in the case where the vehicle control unit 64 performs the stop control.

In the above configuration, the vehicle occupant can understand the reason why the host vehicle 10 has decelerated or stopped.

The vehicle control device 12 further includes the notification control unit 66 configured to perform the notification control to prompt the vehicle occupant of the host vehicle 10 to select whether to temporarily stop the host vehicle 10 before the track 124 or not. The stop position setting unit 60 is configured to set the target stop position 128 in the case where the vehicle occupant selects to stop the host vehicle 10.

In the above configuration, the automated driving in accordance with the vehicle occupant's intention can be performed. For example, if the vehicle occupant confirms that the streetcar 104 will not approach the position where the host vehicle 10 crosses the track 124, the operation of temporarily stopping the host vehicle 10 before the track 124 can be omitted.

If the external environment recognition unit 54 does not recognize the stop line between the host vehicle 10 and the track 124, the stop position setting unit 60 is configured to set the position that is separated from the track 124 toward the host vehicle 10 by the predetermined distance D1 as the target stop position 128.

In the above configuration, even if the stop line cannot be recognized, the target stop position 128 can be set as long as the position of the track 124 can be recognized.

If the external environment recognition unit 54 does not recognize the stop line between the host vehicle 10 and the track 124, the stop position setting unit 60 is configured to set as the target stop position 128, the position where the color of the road surface changes between the host vehicle 10 and the track 124 or the position that is separated from the position where the color of the road surface changes by the predetermined distance D2.

In the above configuration, even if the stop line cannot be recognized, the target stop position 128 can be set as long as the position where the color of the road surface changes can be recognized.

If the host vehicle 10 goes straight to cross the track 124 of the streetcar 104 and the external environment recognition unit 54 does not recognize the stop line between the host vehicle 10 and the track 124, the stop position setting unit 60 is configured to set as the target stop position 128, the position where the preceding vehicle 106 that travels ahead of the host vehicle 10 stops.

In the above configuration, even if the stop line cannot be recognized, the target stop position 128 can be set as long as the position where the preceding vehicle 106 stops can be recognized.

If the host vehicle 10 goes straight to cross the track 124 of the streetcar 104 and the external environment recognition unit 54 does not recognize the stop line between the host vehicle 10 and the track 124, the stop position setting unit 60 is configured to set as the target stop position 128, the position that is separated by the predetermined distance D3 from the position where the oncoming vehicle 108 that travels toward the host vehicle 10 stops.

In the above configuration, even if the stop line cannot be recognized, the target stop position 128 can be set as long as the position where the oncoming vehicle 108 stops can be recognized.

The vehicle control device according to the present invention is not limited to the embodiment above, and can employ various configurations without departing from the concept of the present invention.

What is claimed is:

1. A vehicle control device comprising:
an external environment recognition unit configured to recognize a peripheral state of a host vehicle;
a stop position setting unit configured to set a target stop position of the host vehicle on a basis of the peripheral state that is recognized by the external environment recognition unit; and
a vehicle control unit configured to perform stop control to temporarily stop the host vehicle at the target stop position that is set by the stop position setting unit, wherein:
if the host vehicle crosses a track of a streetcar and the external environment recognition unit recognizes a stop line between the host vehicle and the track, the stop position setting unit is configured to set the stop line as the target stop position; and
if the host vehicle crosses the track of the streetcar and the external environment recognition unit does not recognize the stop line between the host vehicle and the track, the stop position setting unit is configured to set a predetermined position that is separated from the track toward the host vehicle as the target stop position.

2. The vehicle control device according to claim 1, further comprising a notification control unit configured to perform notification control to notify a reason to stop to a vehicle occupant of the host vehicle in a case where the vehicle control unit performs the stop control.

3. The vehicle control device according to claim 1, further comprising a notification control unit configured to perform notification control to prompt a vehicle occupant of the host vehicle to select whether to temporarily stop the host vehicle before the track or not, wherein the stop position setting unit is configured to set the target stop position in a case where the vehicle occupant selects to stop the host vehicle.

4. The vehicle control device according to claim 1, wherein if the external environment recognition unit does not recognize the stop line between the host vehicle and the track, the stop position setting unit is configured to set a position that is separated from the track toward the host vehicle by a predetermined distance as the target stop position.

5. The vehicle control device according to claim 1, wherein if the external environment recognition unit does not recognize the stop line between the host vehicle and the track, the stop position setting unit is configured to set as the target stop position, a position where a color of a road surface changes between the host vehicle and the track or a position that is separated from the position where the color of the road surface changes by a predetermined distance.

6. The vehicle control device according to claim 1, wherein if the host vehicle goes straight to cross the track of the streetcar and the external environment recognition unit does not recognize the stop line between the host vehicle and the track, the stop position setting unit is configured to set as the target stop position, a position where a preceding vehicle that travels ahead of the host vehicle stops.

7. The vehicle control device according to claim 1, wherein if the host vehicle goes straight to cross the track of the streetcar and the external environment recognition unit does not recognize the stop line between the host vehicle and the track, the stop position setting unit is configured to set as the target stop position, a position that is separated by a predetermined distance from a position where an oncoming vehicle that travels toward the host vehicle stops.
